(19) United States
(12) Patent Application Publication
(10) Pub. No.: US 2002/0139034 A1
(43) Pub. Date: Oct. 3, 2002

(54) Electronic fish attractor

(76) Inventor: Robert E. Kane, Sandpoint, ID (US)

Correspondence Address: ROBERT E. KANE, P.O. Box 280, San Luis Rey, CA, 92068, US

(21) Appl. No.: 09/821,635

(22) Filed: Mar. 29, 2001

(51) Int. Cl. A01K 79/02

(52) U.S. Cl. 43/17.1

(57) ABSTRACT

Improvements are described in the use of Sight, Sound, Vibration and Electric current that creates impulses to the fishes senses, and acts in a natural way as a catalyst through which attraction is made. This combination is utilized in a single package that is disposable after hundreds of hours of use. By placing the invention in the water (fresh or salt) the device begins to automatically send out the combination of alluring signals to the fishes +senses. The invention allows the fisherman to utilize several catalistic sense activators in one small inexpensive disposable package.

### BACKGROUND OF THE INVENTION

For hundreds of years engineers and fisherman alike have had but one goal—to attract as many and as large a fish as possible. The peculiar problem in designing attractors to do this is that in order to fully respond to all types of fish more than one sensory device must be applied, until now only a single mode of attraction was relied on. While older methods may have produced relatively large quantities of fish being attracted, they did not produced the larger fish desired to their satisfaction. Lower quantities of these larger fish were attracted. Similarly, by using only one sensory attraction this effectively alters the size ratio of fish being attracted to the area.

Attracting more and larger fish can be accomplished by using more of the fishes natural sensory attributes and can be attracted more readily by utilizing this invention which generates four of the five natural sensory devices within the fish, which is light, sound/vibration and electric potential. The present invention reacts as a catalyst by generation these functions to produce a natural attraction to the fish. The positive effect is present in the amount and size of the fish attracted to the area as soon as the invention is placed into the water. These positive results are present throughout the normal operating spectrums of 300 feet in an omni direction in water. The implementation of such an attraction is apparent when the present invention is used towards the top of the water floating or when the present invention is submerged to the bottom or anywhere in between. The invention brings an instant overall reaction to the senses of the fish in the area of propagation. The invention works equally well when used in fresh or salt water. Confirmation of the invention is easily made by the utilization of a fish finder, confirming, more and larger fish attracted to an area that is influenced by the invention, than when not used.

### SUMMARY OF THE INVENTION

In accordance with one aspect of the present invention, a system is provided for four of the five sensory organs of the fish to be affected, which in turn affects all sizes and all dimensions. The present invention, which generates a catylistic influence within the fish itself, to be attracted to the area of influence, which inturn allows for fisherman to catch larger fish and more quantity of fish.

Reactions of the multiple catalyst upon the fish is immediately apparent as soon as the conditioned water propergates out to reach the fish in the area of influence. When the invention is in use the reaction of attraction is verifiable by fish finders and are measured within the area of influence and the reaction is immediately apparent each and every time.

### OPERATION

To understand the operation of the invention we must understand the natural senses of the fish, there are five in number and are most basic known to man supported by Scientists in Aquatic and Marine Science World-Wide.

Successful survival in any environment depends upon an organism's ability to acquire information from its environment through its senses. Fish have many of the same senses that we have, they can see, smell, touch, feel, and taste, and they have developed some senses that we don't have, such as electroreception. Fish can sense light, chemicals, sound/vibrations and electricity.

Light: Photoreception [Vision].

Fish have a very keen sense of vision, which helps them to find food, shelter, mates, and avoid predators. Fish vision is on par with our own vision; many can see in color, and some can see in extremely dim light. Light is broken into its components when it hits the water and certain waves (colors) penetrate to different depths depending on the clarity of the water. In muddy water the color Red is best. Overall the combination of Black and Red seems to be best.

Ref: Studies by a Ph.D. in Aquatic and Marine Science from Texas A&M. USA.

The present invention propagates a flashing Red colored spectrum.

Fish eyes are different from our own. Their lenses are perfectly spherical, which enables them to see underwater because it has a higher refractive index to help them focus. They focus by moving the lens in and out instead of stretching it like we do. They cannot dilate or contract their pupils because the lens bulges through the iris. As the depth at which fish are found increases, the resident fish's eye sizes increase in order to gather the dimmer light. This process continues until the end of the photic zone, where eye size drops off as their is no light to see with. Nocturnal fish tend to have larger eyes then diurnal fish. Just look at a squirrelfish, and you will see this to be so. Some fish have a special eye structure known as the Tapetum lucidum, which amplifies the incoming light. It is a layer of guanine crystals which glow at night. Photons which pass the retina get bounced back to be detected again. If the photons are still not absorbed, they are reflected back out of the eye. On a night dive, you may see these reflections as you shine your light around!

Chemicals: Chemoreception [Smell and Taste].

Chemoreception is very well developed in the fishes, especially the sharks and eels which rely upon this to detect their prey. Fish have two nostrils on each side of their head, and there is no connection between the nostrils and the throat. The olfactory rosette is the organ that detects the chemicals. The size of the rosette is proportional to the fish's ability to smell. Some fish (such as sharks, rays, eels, and salmon) can detect chemical levels as low as 1 part per billion.

Fish also have the ability to taste. They have taste buds on their lips, tongue, and all over their mouths. Some fish, such as the goatfish or catfish, have barbels, which are whiskers that have taste structures. Goatfish can be seen digging through the sand with their barbels looking for invertebrate worms to eat and can taste them before they even reach their mouths.

Vibrations: Mechanoreception [Sound and Vibration].

Sound and vibration travel four times faster in water then they do in air.

In water waves are transmitted at 5,000 feet per second.

The present invention propagates SPW, a Sonic Pulsed Wave form by way of a transducer.

Have you ever seen a fish's ear. Probably not, but they do have them, located within their bodies as well as a lateral line system that actually lets them feel their surroundings.

Fish do not have external ears, but sound vibrations readily transmit from the water through the fish's body to its internal ears. The ears are divided into two sections, an upper section (pars superior) and a lower section (utriculus) The pars superior is divided into three semicircular canals and give the fish its sense of balance. It is fluid-filled with sensory hairs. The sensory hairs detect the rotational acceleration of the fluid. The canals are arranged so that one gives yaw, another pitch, and the last—roll. The utriculus gives the fish its ability to hear. It has two large otoliths which vibrate with the sound and stimulate surrounding hair cells.

Fish posses another sense of mechanoreception that is kind of like a cross between hearing and touch. The organ responsible for this is the neuromast, a cluster of hair cells which have their hairs linked in a glob of jelly known as ‘cupala’. All fish posses free neuromasts, which come in contact directly with the water. Most fish have a series of neuromasts not in direct contact with the water. These are arranged linearly and form the fishes lateral lines. A free neuromast gives the fish directional input.

A lateral line receives signals stimulated in a sequence, and gives the fish much more information (feeling the other fish around it for polarized schooling, and short-range prey detection ‘the sense of distant touch’).

Electricity: Electroreception.

Sharks and rays posses special organs for detecting electrical potential [voltage]. A set of pits comprise the electroreceptive system called the ampullae of Lorenzini. These are canals in the skin filled with a gelatin-like material that also contain sensory cells. Movements or disturbances near the shark change the voltage drop along the canals, which allows the shark to sense other organisms nearby. These sensors are so sensitive that if there were not any other distortions a shark could detect the heartbeat of a fish, or the touching together the leads of a wire 500 miles apart connected to a 1½ volt battery. They can detect muscular contractions of struggling prey and even the earth's magnetic field (which sharks use for navigation). The present invention propagates an omni directional electrical frequency pattern in water.

### BRIEF DESCRIPTION OF THE PHOTO'S

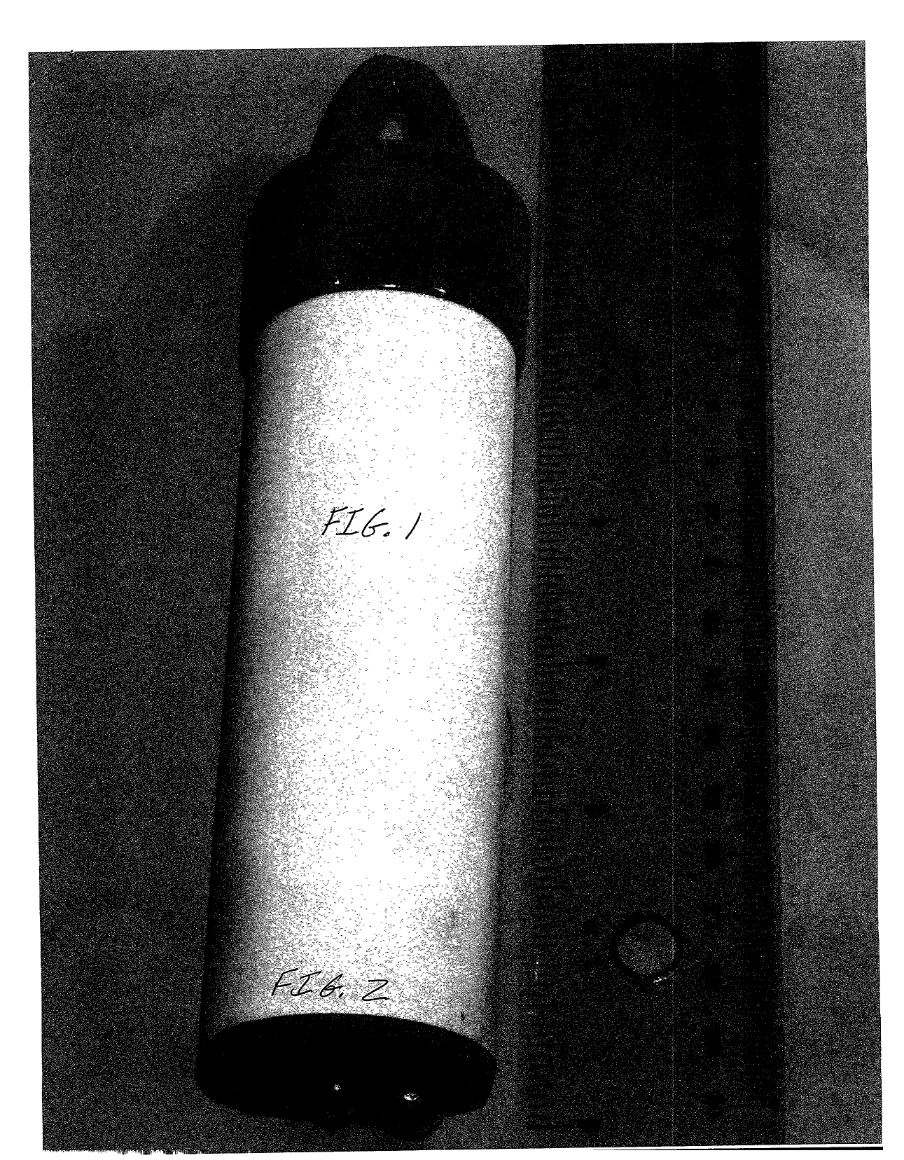

FIG. 1 is a simplified schematic overview of an embodiment capable of housing the invention.

FIG. 2 is an isometric view of the under side of an embodiment that encapsulates the invention.

### DESCRIPTION OF THE PREFERRED EMBODIMENT

FIG. 1 illustrates a system of the present invention that is placed over the top encapsulating air for bouncy.

Although particular embodiments of the invention have been described and illustrated herein, it is recognized that modifications and variations may readily occur to those skilled in the art, and consequently, it is intended that the claims be interpreted to cover such modifications and equivalents.

1. A single container, consisting of a light, sound/vibration and electrical propagation source.

2. The invention described in claim 1 wherein:
Container may be buoyant, or submerged.

3. The invention described in claim 1 wherein:
The device is self contained, and disposible.
